(19) United States
(12) Patent Application Publication
(10) Pub. No.: US 2013/0117133 A1
(43) Pub. Date: May 9, 2013

(54) SYSTEMS AND METHODS FOR RAPID AD CREATION, INCLUDING BATCH-ADS, USING A COMPATIBLE MOBILE DEVICE, FOR AN ONLINE MARKETPLACE

(71) Applicants: Karim PIRANI, San Diego, CA (US); Douglas BREWER, La Costa, CA (US); Robert PEDERSON, San Diego, CA (US); Alma QUINN, San Diego, CA (US); Patrick PETERHANS, San Diego, CA (US)

(72) Inventors: Karim PIRANI, San Diego, CA (US); Douglas BREWER, La Costa, CA (US); Robert PEDERSON, San Diego, CA (US); Alma QUINN, San Diego, CA (US); Patrick PETERHANS, San Diego, CA (US)

(21) Appl. No.: 13/669,332

(22) Filed: Nov. 5, 2012

Related U.S. Application Data
(60) Provisional application No. 61/556,072, filed on Nov. 4, 2011.

(51) Int. Cl. G06Q 30/02

(52) U.S. Cl. CPC G06Q 30/0276
USPC 705/14.72

(57) ABSTRACT

This invention details systems and methods for users in an online marketplace to easily enter one or more items using a smartphone or other compatible mobile device, then uploading the newly entered item(s) in a batch upload process directly onto the online marketplace. One aspect of the invention describes the process of using a mobile device to photograph or add images and easily capture the primary information needed for an ad listing. The process of capturing the detailed information utilizes a mobile device's voice recognition technology as an alternative to the device's keypad to streamline the data entry process. A second aspect of the invention details the system's process of batch uploading the final items directly into the online marketplace. The final aspect of the invention describes the process whereby a user may later login to the web-based system to edit or add optional details to the ad listing if desired.

### RELATED APPLICATION

This patent application claims the benefit of and priority to U.S. provisional patent application Ser. No. 61/556,072, filed 04 Nov. 2011 (attorney docket number SAF-0110-PV), which is hereby incorporated by reference in its entirety for any and all purposes.

### BACKGROUND

As the popularity of smartphones, tablets and other mobile devices continues to increase, it is becoming more commonplace for ecommerce transactions to be conducted via mobile devices. At the same time, more and more household goods that previously may have been sold through garage sales are now being sold through online marketplaces. In addition, advances in mobile technology are making it much easier to capture information from any location.

Online marketplaces offer an alternative to garage sales for homeowners looking to sell unwanted goods. One challenge that homeowners face in selling multiple items in an online marketplace is the onerous process of manually itemizing, photographing, describing and entering all relevant details into a web-based marketplace. For an individual with a garage full of items this can be a very time consuming process of manually cataloging items, then reentering the information in a web-based form. This invention is designed to create a simple process for users to use a compatible mobile device such as a smartphone, tablet, or a portable media player to capture via voice recognition technology or device keypad, and device camera, all relevant information needed to post a listing directly to an online marketplace. The system will allow for multiple items to be added sequentially and once the user is finished adding items, the user will then be able to upload the completed batch of items as individual ad listings to appear in the online marketplace. Subsequently the user may login to the website and add additional details if desired.

### SUMMARY OF THE INVENTION

This invention details systems and methods by which a user of an online marketplace can capture all of the required information and images defining a new ad listing using a mobile device. This invention further details the process of uploading through a batch process, multiple item listings to the online marketplace and methods by which the user may later edit these ad listings.

### DESCRIPTION OF THE DRAWINGS

FIG. 1 is a flowchart illustrating the process by which a user uses a compatible mobile device to enter descriptive text and optional image(s) for one or more ad listings. The descriptive text can be entered either by using the device's keypad or the device's voice recognition technology (if available). The images may be created using the device's camera or uploaded from images stored on the device. After the user is finished creating new ads, the user may either save the ad(s) to a pending ad list for later editing or upload the new ads directly into the live marketplace for other users to see.

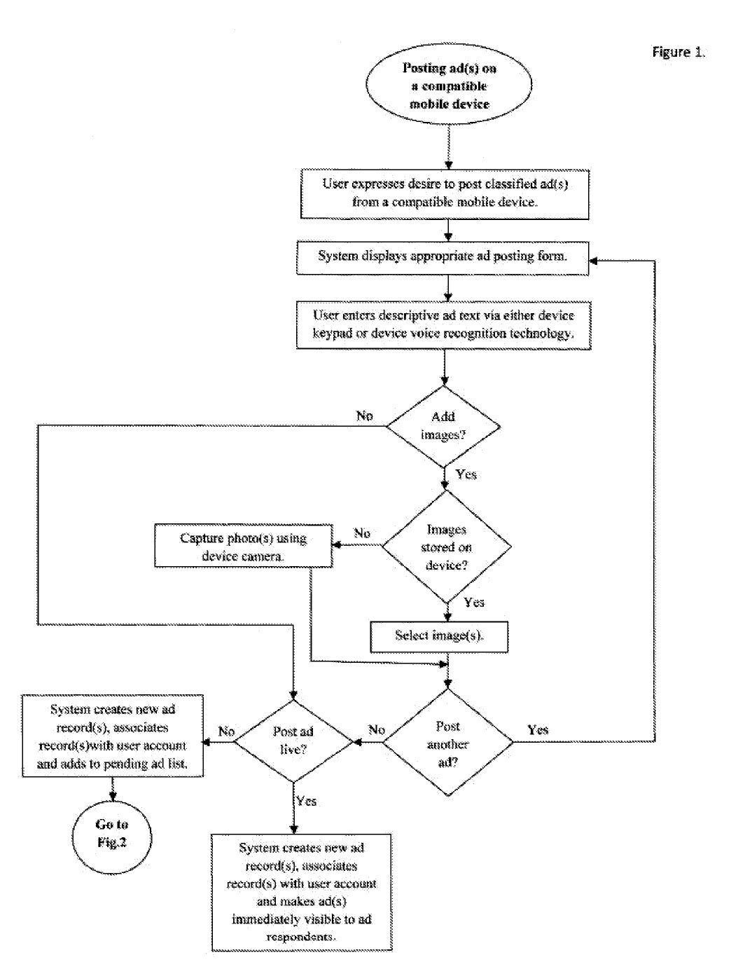

FIG. 2 is a flowchart illustrating the process for viewing and editing pending ads. From this process, the user may also post ads directly to the live marketplace for other users to see.

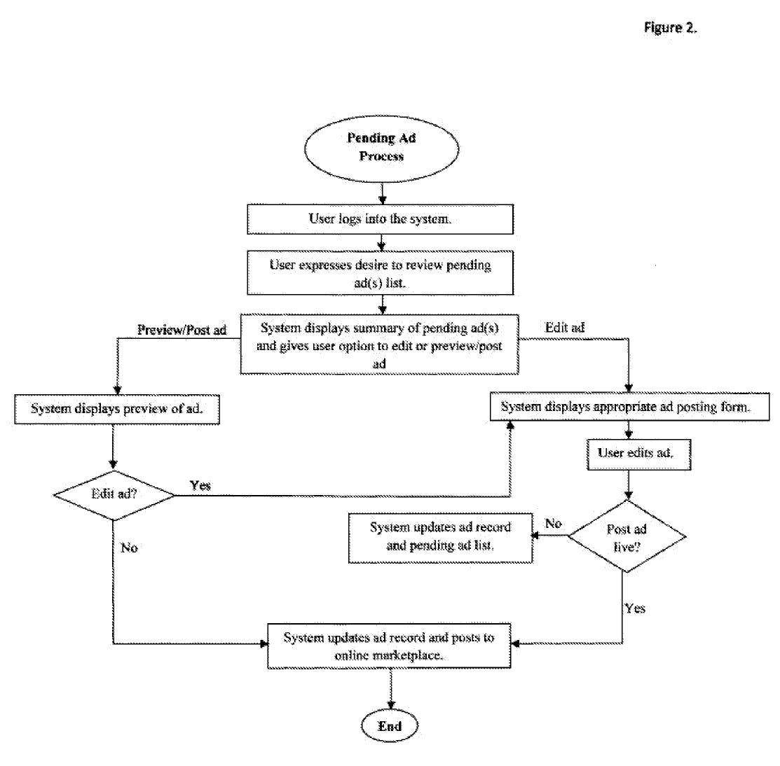

What is claimed is:

1. Systems and methods for enabling single or batch uploading of ad listings to an online marketplace using a smartphone or other compatible portable device. The method consisting of: (A) a registered user initiating a new ad posting process using a compatible mobile device; (B) the user individually entering item's descriptive text into the mobile device either by directly typing into the device's keypad or alternatively by using a mobile device's voice recognition application; (C) the user optionally adding one or more photos to be associated with the ad listing, either by taking photos directly from the mobile device or by uploading previous images directly from the mobile device; (D) the system creating a new ad record, associating the descriptive text and images to that ad record; (E) the user indicating that the batch ad creation process is complete through the application interface; (F) the system uploading the user entered data and images to the online marketplace database and creating new ad records for each distinct ad listing; (G) the system either updating the online marketplace to display the new ad listings; or (H) the system adding the new ad listings to the user's account so that the user may further add details and edit the listings by logging into the website.
